(19) United States
(12) Patent Application Publication
(10) Pub. No.: US 2011/0307980 A1
(43) Pub. Date: Dec. 15, 2011

(54) HIGH-SPEED AND HIGH-RESOLUTION ATOMIC FORCE MICROSCOPE

(75) Inventors: Yonmook Park, Suwon-si (KR); Dong Min Kim, Suwon-si (KR)

(73) Assignee: SAMSUNG ELECTRONICS CO., LTD., Suwon-si (KR)

(21) Appl. No.: 13/114,642

(22) Filed: May 24, 2011

(30) Foreign Application Priority Data
Jun. 14, 2010 (KR) 10-2010-0056055

(51) Int. Cl. G01Q 60/24

(52) U.S. Cl. 850/33

(57) ABSTRACT

According to example embodiments, an atomic force microscope includes a probe tip, a cantilever including the probe tip, a displacement measurement device, and a movement device. A vibrating displacement of the cantilever changes according to a force between atoms of the probe tip and atoms of a surface of a sample. The displacement measurement device is configured to irradiate a beam emitted from a light source on the cantilever and to measure a displacement of the cantilever based on the beam reflected from the cantilever. The movement device is configured to move the cantilever and the displacement measurement device simultaneously when the sample is scanned.

### CROSS-REFERENCE TO RELATED APPLICATION

This application claims priority under 35 U.S.C. §119 to Korean Patent Application No. 2010-0056055, filed on Jun. 14, 2010 in the Korean Intellectual Property Office, the entire disclosure of which is incorporated herein by reference.

### BACKGROUND

1. Field

Example embodiments relate to an atomic force microscope (AFM) which measures a microstructure of the surface of a sample in such a manner in that a vibrating displacement of a cantilever provided with a probe tip is detected by means of atomic force applied between the probe tip and the sample by causing the cantilever to scan the sample surface.

2. Description of the Related Art

An atomic force microscope has a high measuring resolution of a sub-nanometer level in a direction of the Z-axis, for example, in a height direction of a sample, and thus is considered as a next-generation high-precision measurement system to obtain a three-dimensional topography of the sample (in directions of the X-axis, Y-axis, and Z-axis) in various industrial fields needing high precision, such as semiconductors, LCDs, and biology.

In order to obtain a three-dimensional topography of the sample, as a cantilever or the sample moves relatively in the directions of the X-axis and the Y-axis in a plane in which the sample is located, a shape of the sample in the direction of the Z-axis is detected by measuring Van der Waals force applied between a probe tip attached to the end of the cantilever in the direction of the Z-axis and atoms of the sample.

The conventional atomic force microscope does not achieve high-speed measurement due to mechanical or physical limitations thereof.

### SUMMARY

According to example embodiments, an atomic force microscope includes a probe tip, a cantilever including the probe tip, a displacement measurement device configured to irradiate a beam emitted from a light source on the cantilever and to measure a displacement of the cantilever based on the beam reflected from the cantilever, and a movement device configured to move the cantilever and the displacement measurement device simultaneously when the sample is scanned. A vibrating displacement of the cantilever changes according to a force between atoms of the probe tip and atoms of a surface of a sample;

According to example embodiments, the movement device includes a first scanner configured to move the displacement measurement device and the cantilever in a direction of a plane on which the sample is placed, and a second scanner configured to move the cantilever in a direction perpendicular to the direction of the plane on which the sample is placed.

According to example embodiments, the cantilever includes an actuator configured to vibrate the cantilever in the direction perpendicular to the direction of the plane on which the sample is placed.

According to example embodiments, the actuator is a scanner having a shorter stroke length than that of the second scanner.

According to example embodiments, the atomic force microscope further includes a piezoelectric actuator between the second scanner and the cantilever, the piezoelectric actuator configured to vibrate the cantilever in the direction perpendicular to the direction of the plane on which the sample is placed.

According to example embodiments, the piezoelectric actuator is a scanner having a shorter stroke length than that of the second scanner.

According to example embodiments, the displacement measurement device includes, the light source on a main body of the atomic force microscope, a condensing lens on the main body of the atomic force microscope, and a photo detector on the main body of the atomic force microscope. The light source is configured to irradiate a beam on the cantilever, The condensing lens is configured to concentrate the beam irradiated from the light source and to transmit the concentrated beam to the surface of the cantilever. The photo detector is configured to receive the beam reflected from the surface of the cantilever through the condensing lens.

According to example embodiments, the displacement measurement device further includes a beam splitter configured to reflect the beam emitted from the light source to the condensing lens.

According to example embodiments, the displacement measurement device further includes, a first position alignment device configured to align a position of the light source, and a second position alignment device configured to align a position of the photo detector.

According to example embodiments, an atomic force microscope includes a probe tip, a cantilever including the probe tip, a light source configured to irradiate a beam on the cantilever, a condensing lens configured to concentrate the beam irradiated from the light source and to transmit the concentrated beam to the surface of the cantilever, a photo detector configured to receive the beam reflected from the surface of the cantilever through the condensing lens, a first scanner configured to move the cantilever, the light source, the condensing lens, and the photo detector simultaneously in a direction of a plane on which the sample is placed when the sample is scanned, and a second scanner configured to move the cantilever in a direction perpendicular to the direction of the plane on which the sample is placed when the sample is scanned. A vibrating displacement of the cantilever changes according to force between atoms of the probe tip and atoms of a surface of a sample;

According to example embodiments, the atomic force microscope, further includes a beam splitter configured to reflect the beam emitted from the light source to the condensing lens.

According to example embodiments, the cantilever includes an actuator configured to vibrate the cantilever in the direction perpendicular to the direction of the plane on which the sample is placed, or a piezoelectric actuator between the second scanner and the cantilever, the piezoelectric actuator configured to vibrate the cantilever in a direction perpendicular to a direction of the plane in which the sample is placed.

According to example embodiments, the actuator or the piezoelectric actuator is a scanner having a shorter stroke length than that of the second scanner.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a schematic sectional view of an atomic force microscope, according to example embodiments;

FIG. 2 is a view illustrating a method of scanning a sample shown in FIG. 1 in a direction of the X-axis and a direction of the Y-axis; and

FIG. 3 is a schematic sectional view of an atomic force microscope, according to example embodiments.

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

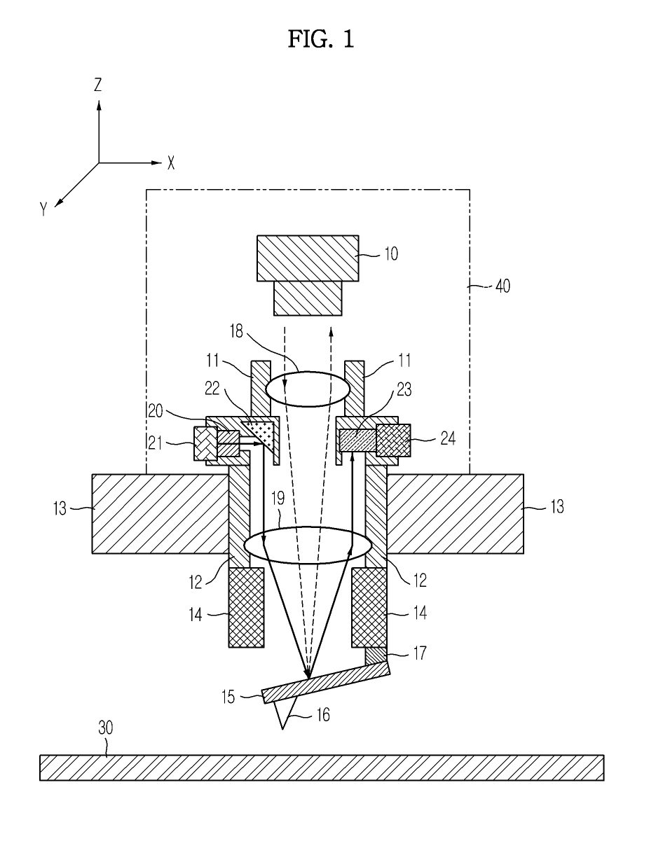

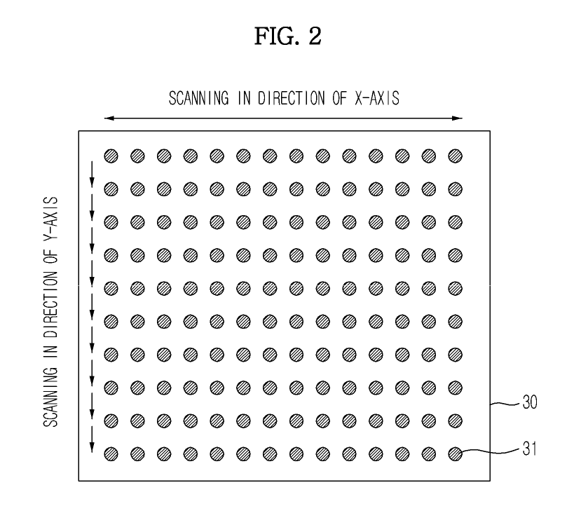

FIG. 1 is a schematic sectional view of an atomic force microscope, according to example embodiments, and FIG. 2 is a view illustrating a method of scanning a sample shown in FIG. 1 in a direction of the X-axis and a direction of the Y-axis.

As shown in FIGS. 1 and 2, the atomic force microscope, according to example embodiments, includes an optical system 10, a main body 11 and 12, a first scanner 13, a second scanner 14, a cantilever 15, a probe tip 16, a piezoelectric actuator 17, a first condensing lens 18, a second condensing lens 19, a light source 20, a first position alignment device 21, a beam splitter 22, an photo detector 23, and/or a second position alignment device 24.

The optical system 10 is provided at an opening of the upper portion of the main body 11 and 12, and serves to check arrival of a beam to the surface of the cantilever 15 and approach of the cantilever 15 to a desired point of a sample 30. The optical system 10 may be provided separately.

The optical system 10 captures an image using a charge coupled device (CCD) sensor and a lens, for example.

The main body 11 and 12 includes a first frame member 11 and a second frame member 12.

The first frame member 11 and the second frame member 12 are connected.

The first frame member 11 is provided at a higher position than the second frame member 12.

The first scanner 13 and the second scanner 14 constitute a movement device to move the main body 11 and 12 and the cantilever 15, simultaneously. That is, the movement device moves the main body 11 and 12 and the cantilever 15 in directions of the X-axis, the Y-axis, and the Z-axis.

The first scanner 13 is provided on the first frame member 11, and moves the main body 11 and 12 such that the cantilever 15 is movable in the directions of the X-axis and the Y-axis on a plane.

The second scanner 14 is provided on the second frame member 12, and moves the cantilever 15 in a direction perpendicular to the plane.

The probe tip 16 is provided on the cantilever 15. The probe tip 16 induces Van der Waals force with the sample 30.

When the probe tip 16 approaches the surface of the sample 30, interacting force occurs between atoms of the end of the probe tip 16 and atoms of the surface of the sample 30, and the cantilever 15 connected with the probe tip 16 bends upwards and downwards. Such interacting force is referred to as Van der Waals force.

The probe tip 16 is attached to a free end (end of the cantilever 15 not connected to the main body, for example) of the cantilever 15, and actuating displacement of the cantilever 15 is changed by Van der Waals force between the probe tip 16 and the sample 30. One or plural probe tips 16 and one or plural cantilevers 15 may be provided.

The cantilever 15 may include an actuator to vibrate the cantilever 15, and a displacement sensor provided to measure vibrating displacement of the cantilever 15.

The actuator, for example, vibrates the cantilever 15 in the direction of the Z-axis. The displacement sensor, for example, measures the vibrating displacement of the cantilever 15 in the direction of the Z-axis.

The actuator includes a piezoelectric actuator or a thermal actuator, and vibrates the cantilever 15 at a high speed in the direction of the Z-axis.

The piezoelectric actuator is an actuator using a piezoelectric material, actuating displacement of which is changed when voltage (for example, an alternating voltage) is applied thereto. The thermal actuator is an actuator using a bimetal material, actuating displacement of which is changed by means of a bimetal effect when voltage is applied to two materials having different coefficients of thermal expansion.

The displacement sensor includes a piezoresistive sensor. The piezoresistive sensor is a sensor in which resistance of a piezoelectric material is changed according to change in displacement of the piezoelectric material.

When voltage is supplied to the piezoelectric actuator or the thermal actuator of the cantilever 15, the cantilever 15 reciprocates in directions of the positive Z-axis and the negative Z-axis and thus vibrates. When the cantilever 15 vibrates, a resistance value of the piezoresistive sensor is changed.

Therefore, actuating displacement of the cantilever 15 is measured by sensing change in output of the piezoresistive sensor.

Instead of the actuator of the cantilever 15, a piezoelectric actuator 17 to vibrate the cantilever 15 in the direction of the Z-axis may be provided between the cantilever 15 and the second scanner 14. If stroke lengths of the second scanner 14, the piezoelectric actuator 17, and the actuator of the cantilever 15 to scan regions of the sample 30 are compared with each other, the second scanner 14 serves as a long stroke scanner having a relatively long stroke length, the piezoelectric actuator 17 serves as a middle stroke scanner having a relatively middle stroke length, and the actuator of the cantilever 15 serves as a short stroke scanner having a relatively short stroke length.

The first condensing lens 18 concentrates a beam emitted from the optical system 10, to irradiate the concentrated beam onto the surface of the cantilever 15, and then to transmit the beam reflected from the surface of the cantilever 15 to the optical system 10.

The light source 20, the first position alignment device 21, the beam splitter 22, the second condensing lens 19, the photo detector 23, and the second position alignment device 24 constitute a displacement measurement device to measure actuating displacement of the cantilever 15. That is, the displacement measurement device irradiates a beam emitted from the light source 20 onto the cantilever 15, and measures displacement of the cantilever 15 from the beam reflected from the cantilever 15.

The light source 20 is provided above the cantilever 15, and irradiates a beam onto the cantilever 15 so as to measure actuating displacement of the cantilever 15.

The light source 20 may be a laser diode to generate a laser beam, for example.

At least one first position alignment device 21 to align the position of the light source 20 is attached to the light source 20.

The first position alignment device 21 finely adjusts the position of the light source 20.

The beam splitter 22 reflects the beam emitted from the light source 20 toward the second condensing lens 19.

The second condensing lens 19 concentrates the beam reflected from the beam splitter 22, to irradiate the concentrated beam onto the surface of the cantilever 15, and then to transmit the beam reflected from the surface of the cantilever 15 to the photo detector 23.

The photo detector 23 measures the beam reflected from the surface of the cantilever 15.

At least one second position alignment device 24 to align the position of the photo detector 23 is attached to the photo detector 23.

The photo detector 23 may be a position sensitive photo detector (PSPD), for example.

The second position alignment device 24 finely adjusts the position of the photo detector 23.

Here, reference numeral 40 represents a coarse approach system. The coarse approach system 40 is a system to simultaneously move the optical system 10, the main body 11 and 12, the first scanner 13, the second scanner 14, the cantilever 15, the probe tip 16, the piezoelectric actuator 17, the first condensing lens 18, the second condensing lens 19, the light source 20, the first position alignment device 21, the beam splitter 22, the photo detector 23, and/or the second position alignment device 24 in/away from the direction of the sample 30.

Now, operation of the atomic force microscope, according to example embodiments, will be described. First, it is checked whether or not a beam approaches the surface of the cantilever 15 through the optical system 10.

When it is confirmed that the beam approaches the surface of the cantilever 15, the first position alignment device 21 aligns the position of the light source 20 so that the beam approaches/is incident on a desired position of the surface of the cantilever 15.

Here, the second position alignment device 24 aligns the position of the photo detector 23 so that the beam reflected from the surface of the cantilever 15 approaches/is incident on a set position of the photo detector 23.

Thereafter, when the coarse approach system 40 is operated to move the cantilever 15 in the direction of the sample 30 while measuring the actuating displacement of the cantilever 15 using the photo detector 23, attractive force applied between atoms of the probe tip 16 provided on the cantilever 15 and atoms of the sample 30 increases, and thus the probe tip 16 moves in the direction of the sample 30. Here, the coarse approach system 40 simultaneously moves the optical system 10, the main body 11 and 12, the first scanner 13, the second scanner 14, the cantilever 15, the probe tip 16, the piezoelectric actuator 17, the first condensing lens 18, the second condensing lens 19, the light source 20, the first position alignment device 21, the beam splitter 22, the photo detector 23, and/or the second position alignment device 24 in the direction of the sample 30.

Thereby, the cantilever 15 provided with the probe tip 16 bends in the direction of the sample 30, and thus the actuating displacement of the cantilever 15 is changed. Then, the operation of the coarse approach system 40 is stopped, and thus the movement of the cantilever 15 in the direction of the sample 30 is stopped.

Thereafter, the coarse approach system 40 is operated to move the cantilever 15 in the direction of the sample 30 while measuring the actuating displacement of the cantilever 15 using the photo detector 23.

As the cantilever 15 moves in the direction of the sample 30, repulsive force applied between atoms of the probe tip 16 attached to the cantilever 15 and atoms of the sample 30 increases and thus the probe tip 16 moves in the opposite direction to the sample 30. Thereby, the cantilever 15 provided with the probe tip 16 attached thereto bends and actuating displacement of the cantilever 15 is changed.

When the actuating displacement of the cantilever 15 reaches a set position, the actuation of the coarse approach system 40 is stopped and the movement of the cantilever 15 in the direction of the sample 30 is stopped.

Thereafter, the first scanner 13 is precisely actuated in the directions of the X-axis and the Y-axis, and change in the actuating displacement of the cantilever 15 is measured using the photo detector 23 while uniformly controlling the actuating displacement of the cantilever 15 under the condition that the probe tip 16 contacts the sample 30.

Then, a three-dimensional topography of the sample 30 is imaged through the actuating displacement of the cantilever 15. Such a three-dimensional topography is displayed using a separate display.

A method using the displacement measurement device 19˜24 has higher measuring resolution in the direction of the Z-axis than a method using change in resistance due to bending of the cantilever 15, i.e., a method using the cantilever 15 as a displacement sensor.

An actuating speed in the direction of the Z-axis is a relatively significant factor affecting the measuring speed of the atomic force microscope. A scanner using a piezoelectric actuator has a limit in increasing a resonant frequency.

Therefore, in order to make up for the above problem, example embodiments include a concept using a combination of the cantilever 15 having the Z-axis actuator, which is actuated by itself, and the second scanner 14.

Here, the cantilever 15 is manufactured in a very small size so as to maximally increase the resonant frequency. If the size of the cantilever 15, which is actuated by itself, is small enough, an actuating region is reduced. The second scanner 14 takes charge of a large actuating range, and thus the cantilever 15 moves only within a small actuating region at a high speed.

Consequently, the use of both the cantilever 15 and the second scanner 14 allows the atomic force microscope to actuate in a larger range in the direction of the Z-axis at a higher speed, compared with the independent use of the second scanner 14.

The resonant frequency required by the first scanner 13 is much lower than that required by the second scanner 14. Therefore, the first scanner 13 is designed such that it has high precision as well as high speed. For this purpose, the first scanner 13 is designed such that it is guided by a flexure.

A flexure guide is designed such that it may move in the directions of the X-axis and the Y-axis and it does not move in other directions, such as the direction of the Z-axis. For this purpose, the flexure is designed such that it mechanically has 2 degrees of freedom in the directions of the X-axis and the Y-axis.

Since the flexure guide uses elastic deformation of the flexure, an actuating region of the flexure guide is generally 100 μm or less. If an actuating region of several tens to several hundreds of mm is required, as in a semiconductor wafer or an LCD substrate, for example, a coarse actuator is combined with the flexure guide. Here, the coarse actuator has a lower speed than that of the first scanner 13, and thus is used to move the overall atomic force microscope.

At this time, the sample 30 is fixed. Further, the coarse actuator may be used to move the overall sample 30. As a result, high-precision actuating resolution of a sub-nanometer level or less may be achieved with respect to an actuating region of several hundreds of mm.

The atomic force microscope may be operated in two measurement modes. One is a contact mode, and the other one is a non-contact mode.

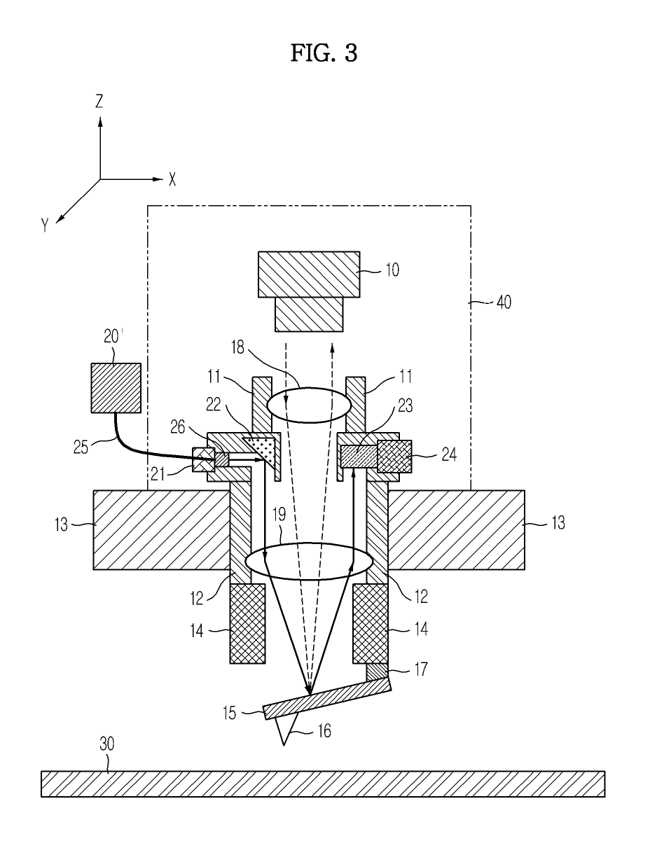

First, in the contact mode, when the first scanner 13 scans the surface of the sample 30, as shown in FIG. 3, a height in the direction of the Z-axis is changed due to the shape of the surface of the sample 30, and thus Van der Waals force between the probe tip 16 attached to the cantilever 15 and the sample 30 is changed.

The second scanner 14 performs scanning while carrying out feedback control so as to uniformly maintain such Van der Waals force or the distance between the probe tip 16 attached to the cantilever 15 and the sample 30. Here, the position of the cantilever 15 moving in the direction of the Z-axis is detected through a value measured by the displacement sensor of the second scanner 14. Such a value becomes the height of the sample 30 in the direction of the Z-axis at each of respective measurement points.

On the other hand, in the non-contact mode, when the cantilever 15 performs scanning while vibrating at a uniform frequency and a uniform amplitude using the tapping piezoelectric actuator, an amplitude is changed according to the height of the sample 30 in the direction of the Z-axis, and the second scanner 14 performs scanning while carrying out feedback control so as to uniformly maintain such an amplitude.

Also, in the non-contact mode, the height of the sample 30 in the direction of the Z-axis is detected by reading a change of the displacement sensor of the second scanner 14.

The atomic force microscope is designed such that an actuating range of the atomic force microscope in the direction of the Z-axis is about 10 μm. In general, heights of samples measured in the industry are about 1˜2 μm. Nonetheless, the reason why the actuating range of the atomic force microscope in the direction of the Z-axis is set to 10 μm is that, if the actuating surface of the first scanner 13 and the surface of the sample 30 are not precisely parallel with each other and particles having a size of several μm are present on the surface of the sample 30, the probe tip 16 may collide with the surface of the sample 30 or the particles and thus may be damaged or broken when the actuating range of the atomic force microscope in the direction of the Z-axis is small.

The atomic force microscope, according to example embodiments, is advantageous in that it uses the cantilever 15 having a relatively higher natural frequency than that of the second scanner 14 during the feedback control of the second scanner 14 and thus rapidly responds. The cantilever 15 is miniaturized so as to achieve high-speed actuation, and thus the actuating range of the cantilever 15 becomes small. That is, the cantilever 15 is designed such that it moves in the range of 1˜2 μm, if the size of a sample to be measured is about 1˜2 μm.

Therefore, the surface shape of the sample 30 in a local region is traced using the cantilever 15, and the height of the sample 30 in a broad region, changed into a relatively low space frequency, is traced using the second scanner 14.

If the change of the surface shape of the sample 30 in overall regions of the sample 30 has a high space frequency and the change of the surface shape of the sample 30 is large so as to exceed the actuating range of the cantilever 15, the scanning speed in the direction of the Z-axis is greatly influenced by the second scanner 14 other than the cantilever 15. In this case, the surface shape of the sample 30 is rapidly traced due to swift response of the cantilever 15.

As a result, a dual servo structure, in which a small measurement region is scanned by the cantilever 15 having a high actuating speed and a large measurement region is scanned by the Z-axis scanner having a lower actuating speed than that of the cantilever 15, is employed, thereby increasing a measurement speed in the direction of the Z-axis.

If the size of the cantilever 15 is manufactured to have an excessively small size, the size of a measurement beam may be reduced. In this case, the size of the beam is reduced by focusing the beam on the surface of the cantilever 15 using the second condensing lens 19. Further, the first condensing lens 18, to optically observe the location of the cantilever 15 on the surface of the sample 30 when the cantilever 15 generally moves to a position on the surface of the sample 30 in which interaction occurs due to Van der Waals force, is provided.

For this purpose, the second scanner 14 is provided with a hole formed at the center thereof to pass the beam. The second scanner 14 may employ a ring type piezoelectric actuator provided with a hole formed at the center thereof, or may employ a plurality of Z-axis actuators connected to each other and provided with a hole formed at the center of the plural Z-axis actuators to pass the beam.

As shown in FIG. 3, if the size of a laser diode is large, a light source 20′ is located external to the first frame member 11, and irradiates a beam onto a third condensing lens 26 through an optical fiber 25. The third condensing lens 26 enables the beam to become a parallel beam or to condense the beam without dispersion of the beam.

In the atomic force microscope, according to example embodiments, the main body 11 and 12 moves together with the movement of the first scanner 13 in terms of the mechanical structure of the atomic force microscope. Therefore, when the first scanner 13 moves, the beam is always irradiated onto the surface of the cantilever 15 without deviation of the beam from the cantilever 15, thereby measuring the displacement of the cantilever 15 in the direction of the Z-axis at any time.

As is apparent from the above description, an atomic force microscope, according to example embodiments, measures a long stoke of several hundreds of mm or more with resolution of a nanometer level at a high speed in semiconductor wafers, LCDs, and biology, and thus is used in various fields, compared with conventional atomic force microscopes which are not widely used in industrial spots due to low measurement speed in spite of high measurement resolution.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. An atomic force microscope comprising:
a probe tip;
a cantilever including the probe tip, wherein a vibrating displacement of the cantilever changes according to a force between atoms of the probe tip and atoms of a surface of a sample;
a displacement measurement device configured to irradiate a beam emitted from a light source on the cantilever and to measure a displacement of the cantilever based on the beam reflected from the cantilever; and
a movement device configured to move the cantilever and the displacement measurement device simultaneously when the sample is scanned.

2. The atomic force microscope according to claim 1, wherein the movement device includes a first scanner configured to move the displacement measurement device and the cantilever in a direction of a plane on which the sample is placed, and a second scanner configured to move the cantilever in a direction perpendicular to the direction of the plane on which the sample is placed.

3. The atomic force microscope according to claim 2, wherein the cantilever includes an actuator configured to vibrate the cantilever in the direction perpendicular to the direction of the plane on which the sample is placed.

4. The atomic force microscope according to claim 3, wherein the actuator is a scanner having a shorter stroke length than that of the second scanner.

5. The atomic force microscope according to claim 2, further comprising:
a piezoelectric actuator between the second scanner and the cantilever, the piezoelectric actuator configured to vibrate the cantilever in the direction perpendicular to the direction of the plane on which the sample is placed.

6. The atomic force microscope according to claim 5, wherein the piezoelectric actuator is a scanner having a shorter stroke length than that of the second scanner.

7. The atomic force microscope according to claim 1, wherein the displacement measurement device includes,
the light source on a main body of the atomic force microscope, the light source configured to irradiate a beam on the cantilever,
a condensing lens on the main body of the atomic force microscope, the condensing lens configured to concentrate the beam irradiated from the light source and to transmit the concentrated beam to the surface of the cantilever, and
a photo detector on the main body of the atomic force microscope, the photo detector configured to receive the beam reflected from the surface of the cantilever through the condensing lens.

8. The atomic force microscope according to claim 7, wherein the displacement measurement device further includes a beam splitter configured to reflect the beam emitted from the light source to the condensing lens.

9. The atomic force microscope according to claim 8, wherein the displacement measurement device further includes,
a first position alignment device configured to align a position of the light source, and
a second position alignment device configured to align a position of the photo detector.

10. An atomic force microscope comprising:
a probe tip;
a cantilever including the probe tip, wherein a vibrating displacement of the cantilever changes according to force between atoms of the probe tip and atoms of a surface of a sample;
a light source configured to irradiate a beam on the cantilever;
a condensing lens configured to concentrate the beam irradiated from the light source and to transmit the concentrated beam to the surface of the cantilever;
a photo detector configured to receive the beam reflected from the surface of the cantilever through the condensing lens;
a first scanner configured to move the cantilever, the light source, the condensing lens, and the photo detector simultaneously in a direction of a plane on which the sample is placed when the sample is scanned; and
a second scanner configured to move the cantilever in a direction perpendicular to the direction of the plane on which the sample is placed when the sample is scanned.

11. The atomic force microscope according to claim 10, further comprising:
a beam splitter configured to reflect the beam emitted from the light source to the condensing lens.

12. The atomic force microscope according to claim 10, wherein the cantilever includes an actuator configured to vibrate the cantilever in the direction perpendicular to the direction of the plane on which the sample is placed, or a piezoelectric actuator between the second scanner and the cantilever, the piezoelectric actuator configured to vibrate the cantilever in a direction perpendicular to a direction of the plane in which the sample is placed.

13. The atomic force microscope according to claim 12, wherein the actuator or the piezoelectric actuator is a scanner having a shorter stroke length than that of the second scanner.
